(19) United States
(12) Patent Application Publication
(10) Pub. No.: US 2009/0105974 A1
(43) Pub. Date: Apr. 23, 2009

(54) LIGHT EMITTING COMPONENT CONTROL APPARATUS AND METHOD THEREOF

(76) Inventors: Tzu-Pin Lin, Tai-Nan City (TW); Hun-Wei Chen, Taoyuan County (TW); Shih-Min Wu, I-Lan Hsien (TW)

Correspondence Address: NORTH AMERICA INTELLECTUAL PROPERTY CORPORATION, P.O. BOX 506, MERRIFIELD, VA, 22116, US

(21) Appl. No.: 12/045,686

(22) Filed: Mar. 10, 2008

(30) Foreign Application Priority Data
Oct. 22, 2007 (TW) 096139496

(51) Int. Cl. G06F 19/00

(52) U.S. Cl. 702/65

(57) ABSTRACT

A light emitting component control device includes a voltage detecting unit, a storage device and a microprocessor. The voltage detecting unit is used for detecting a voltage of at least one light emitting component. The storage device is used for storing a look-up table that comprises a corresponding relation between a plurality of voltages of the light emitting component and a plurality of luminance levels of the light emitting component. The processor is coupled to the voltage detecting unit and the storage device, and is used for determining a luminance level of the light emitting component according to the voltage and the corresponding relation.

### BACKGROUND OF THE INVENTION

1. Field of the Invention

The present invention relates to light emitting component control device, and more particularly, to a light emitting component control device that detects a voltage of a light emitting component and determines a luminance level of the light emitting component according to the voltage, and a related controlling method.

2. Description of the Prior Art

Light sources in a back light unit (BLU) implemented with a plurality of light emitting diodes (LEDs) have become popular in recent years because of their small volume and low power. The luminescent principle of the LED is to produce various colors by mixing three primary colors: red, green and blue respectively produced by a red LED, a green LED and a blue LED in an optical way.

When a liquid crystal displayer (LCD) is used over a long period of time, a large amount of heat is generated and the environment temperature is also increased. Since hot air rises due to its smaller density, the temperature of the upper part of the LCD becomes higher than the lower part of the LCD. The light emitting efficiency of an LED will also decrease as temperature gets higher. In addition, the variation in luminance level for the temperature of a red LED is more sensitive than a green LED or blue LED. As a result, the red light luminance level of the upper part of the LCD will significantly decrease and this produces the problem of color deviation.

To solve this problem, a color sensor is disposed in the BLU for detecting the extent of the luminance level decrease and a feedback circuitry is used to perform a color compensation. The color sensor has to be disposed in a position where it is capable of detecting the luminance level of the LED, however. In addition, the color sensor is not able to perform precise detection since it is easily affected by temperature variation. Thus, not only the feedback signal for the feedback circuitry, but also the complicated optical issue and heat dissipation have to be considered when the color sensor is designed. Furthermore, using the color sensor is quite costly, and a large number of color sensors are needed in order to obtain a good control on BLU. Therefore, the overall production cost increases significantly when adopting the color sensor in the BLU.

### SUMMARY OF THE INVENTION

It is therefore an objective of the present invention to provide a light emitting component control device and a controlling method thereof to solve the above-mentioned problem.

According to the present invention, a light emitting component control device is disclosed. The control device includes at least one voltage detecting unit, a storage device and a microprocessor. The voltage detecting unit is used for detecting a voltage of at least one light emitting component. The storage device is used for storing a look-up table that contains a corresponding relation between a plurality of voltages of the light emitting component and a plurality of luminance levels of the light emitting component. The microprocessor is used for determining a luminance level of the light emitting component according to the voltage and the corresponding relation.

According to the present invention, a controlling method for a light emitting component is further disclosed. The controlling method includes: detecting a voltage of at least one light emitting component; storing a corresponding relation between a plurality of voltages of the light emitting component and a plurality of luminance levels of the light emitting component; and determining a luminance level of the light emitting component according to the voltage and the corresponding relation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a light emitting component control device according to an embodiment of the present invention.

FIG. 2 is a flowchart illustrating an embodiment of a controlling method for a light emitting component according to the present invention.

FIG. 3 is a simplified diagram of a light emitting component control device according to another embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “electrically connect” is intended to mean either an indirect or direct electrical connection. Accordingly, if one device is coupled to another device, that connection may be through a direct electrical connection, or through an indirect electrical connection via other devices and connections.

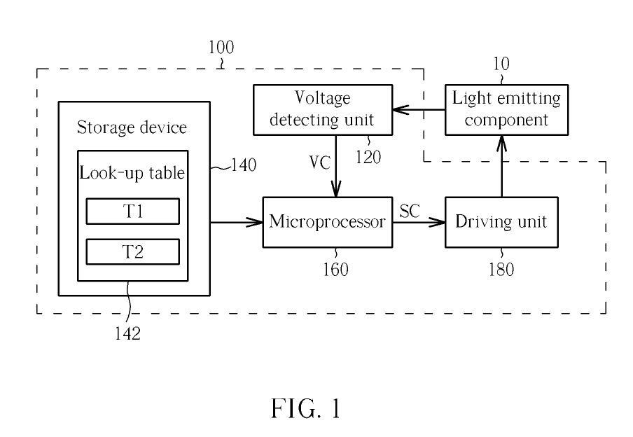

Please refer to FIG. 1. FIG. 1 is a diagram of a light emitting component control device 100 according to an embodiment of the present invention. The light emitting component control device 100 comprises a voltage detecting unit 120, a storage device 140, a microprocessor 160 and a driving unit 180. The voltage detecting unit 120 detects a voltage VC of a light emitting component 10. Please note that there is only one light emitting component (10) and only one voltage detecting unit (120) shown in FIG. 1; the number of light emitting components and voltage detecting units, however, is not limited in the present invention. In addition, the voltage detecting unit 120 can be implemented with a voltmeter in practice. The light emitting component 10 is a light emitting diode (LED), and the voltage is a forward voltage of the LED in one of the embodiments of the present invention; this is, however, for illustrative purposes only and is not deemed to be a limitation of the present invention. The storage device 140 is used for storing a look-up table 142 that comprises a corresponding relation between a plurality of voltages of the light emitting component 10 (e.g., the forward voltage of the LED) and a plurality of luminance levels of the light emitting component. The microprocessor 160 is coupled to the voltage detecting unit 120 and the storage device 140, and is used for determining a luminance level of the light emitting component 10 (e.g., the LED) according to the voltage VC (e.g., the forward voltage) and the corresponding relation in the look-up table 142 and for generating a control signal SC according to the luminance level and a predetermined luminance level. The driving unit 180 is coupled to the microprocessor 160 and the light emitting component 10, and is used for driving the light emitting component 10 according to the control signal SC. Further description of the operation of the light emitting component control device 100 is detailed below. To make the concept of the present invention easily appreciable, an LED is taken as the light emitting component 10 in the following embodiment to illustrate the present invention; this is, however, for illustrative purposes and not a limitation of the prevent invention.

The forward voltage of an LED decreases as temperature gets higher; in other words, there is a voltage-temperature relation for the forward voltage and temperature of the LED. The voltage-temperature relation is stored in a first sub look-up table T1 of the look-up table 142 in the storage device 140. The luminance level of the LED also decreases as temperature gets higher; in other words, there is a luminance-temperature relation for the luminance level and temperature of the LED. The luminance-temperature relation is stored in a second sub look-up table T2 of the look-up table 142 in the storage device 140. Therefore, after the voltage detecting unit 120 obtains a detected forward voltage by detecting the forward voltage of the LED, the microprocessor 160 can determine a current temperature of the LED according to the detected forward voltage and the voltage-temperature relation stored in the first sub look-up table T1 of the look-up table 142 in the storage device 140; and then the microprocessor 160 can determine a luminance level of the LED according to the current temperature of the LED and luminance-temperature relation stored in the second sub look-up table T2 of the look-up table 142 in the storage device 140. That is to say, with the forward voltage detected by the voltage detecting unit 120, the microprocessor 160 can calculate the luminance level of the LED according to the look-up table 142 stored in the microprocessor 160. Please note that obtaining the luminance level by taking advantage of the forward voltage is for illustrative purposes only. Using any other voltages to obtain the luminance level of the light emitting component 10 also falls within the scope of the present invention.

Next, the microprocessor 160 generates a control signal SC to the driving unit 180 according to the calculated luminance level and a predetermined luminance. Then, the driving unit 180 drives the light emitting component 10 according to the control signal SC generated from the microprocessor 160. For example, when the calculated luminance level is higher than the predetermined luminance, the microprocessor 160 generates the control signal SC to adjust the driving unit 180 so that the light emitting component 10 is driven to increase the luminance level of the light emitting component 10. Since the method concerning how the driving unit 180 drives the light emitting component 10 to adjust the luminance level of the light emitting component 10 should be readily appreciated by those skilled in the art, further description is omitted here for the sake of brevity.

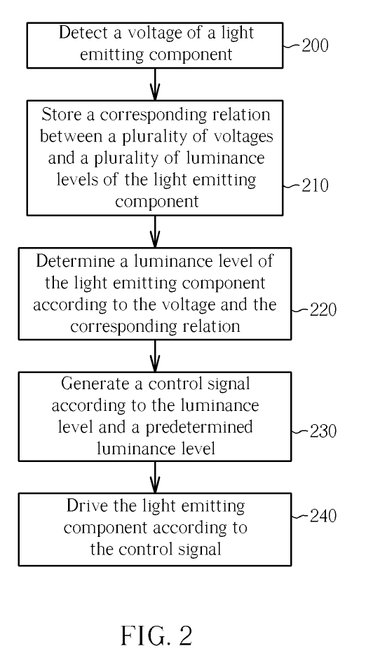

Please refer to FIG. 2. FIG. 2 is a flowchart illustrating an embodiment of a controlling method for a light emitting component according to the present invention. It should be noted that, if the result is substantially the same, the steps in FIG. 2 are not limited to be executed according to the exact order shown in the exemplary flow chart. The steps are as follows:

Step 200: Detect a voltage of at least one light emitting component;

Step 210: Store a corresponding relation between a plurality of voltages of the light emitting component and a plurality of luminance levels of the light emitting component;

Step 220: Determine a luminance level of the light emitting component according to the voltage and the corresponding relation;

Step 230: Generate a control signal according to the luminance level and a predetermined luminance level; and

Step 240: Drive the light emitting component according to the control signal to perform a luminance compensation (a color compensation).

After reading the above-mentioned description concerning the operation for the light emitting component control device 100, the corresponding method in the flow chart shown in FIG. 2 should be readily appreciated by those skilled in the art, so further description is omitted here for the sake of brevity.

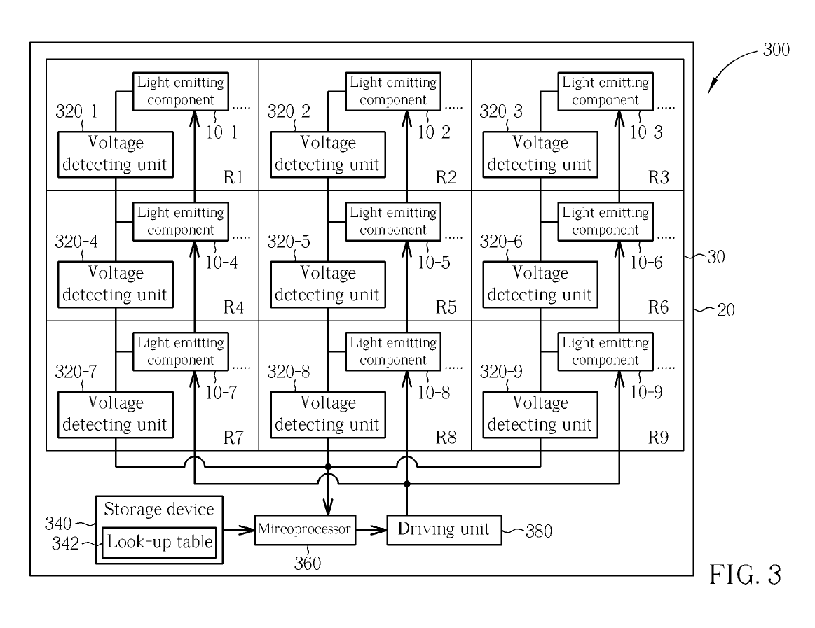

Please refer to FIG. 3. FIG. 3 is a simplified diagram of a light emitting component control device 300 according to an embodiment of the present invention. The light emitting component control device 300 is disposed in a display device 20. As shown in FIG. 3, the display device 20 (e.g., a liquid crystal displayer, LCD) comprises a plurality of light emitting components 10-1, 10-2, . . . , 10-9. In this embodiment, the plurality of light emitting components 10 are a plurality of LEDs. The light emitting component control device 300 comprises a plurality of voltage detecting units 320-1, 320-2, . . . , 320-9, a storage device 340, a microprocessor 360 and a driving unit 380. In this embodiment, the plurality of voltage detecting units 320 are equally distributed in a back light unit 30 (BLU) of the display device 20.

As shown in FIG. 3, the BLU 30 is divided into nine regions R1, R2, . . . , R9. Each of the regions has a plurality of light emitting components 10-1, 10-2, . . . , 10-9 (without affecting the disclosure of the present invention, only one light emitting component is shown in one region in FIG. 3). Each voltage detecting unit is used to detect the voltage of one or more light emitting components in respective region of the plurality of the regions. For example, the voltage detecting units 320-1 are used to detect the voltage of one or more light emitting components 10-1 in the region R1 of the BLU 30, and the voltage detecting units 320-2 are used to detect the voltage of one or more light emitting components 10-2 in the region R2 of the BLU 30, and so on. Then, the plurality of voltage detecting units 320-1, 320-2, . . . , 320-9 respectively transmit the detected voltage to the microprocessor 360. The microprocessor 360 determines the luminance level for every region according to the detected voltage and a look-up table 342 stored in the storage device 340, and controls the driving unit 380 to drive the light emitting components according to the determined luminance level for adjusting the luminance levels of the light emitting components in order to perform a color compensation on the display device 20. Therefore, the light emitting components in each region are capable of outputting the luminance level approximately equal to the predetermined luminance level by utilizing the above-mentioned color compensation. Because operations and functions of the elements of the light emitting component control device 300 shown in FIG. 3 are similar to elements with the same name in the light emitting component control device 100 shown in FIG. 1, further descriptions are not detailed here for the sake of brevity.

Please note that, although the BLU 30 is divided into nine regions R1, R2, . . . , R9 in the above, this is for illustrative purposes only and is not deemed to be a limitation of the present invention. In other words, the BLU 30 can be divided into N regions depending on design requirements, wherein N is any integer and greater than or equal to 1.

Compared with the prior art, the light emitting component control device of the present invention takes advantage of the characteristics of forward voltage and light emitting efficiency of the LED, both of which decrease as temperature gets higher, to perform a color compensation on the BLU via the feedback circuitry in the processor. Since the feedback circuitry detects the forward voltage of the LED, the voltage detecting unit is not limited to be disposed in a position where it is capable of detecting the luminance level of the LED. For example, the voltage detecting unit does not need to be disposed in the BLU. In this way, the complicated optical issue does not need to be considered when the color sensor is designed. In addition, the voltage detecting unit does not easily vary with temperature of the LED and is able to detect the luminance level precisely.

Those skilled in the art will readily observe that numerous modifications and alterations of the device and method may be made while retaining the teachings of the invention.

What is claimed is:

1. A light emitting component control device, comprising:
at least one voltage detecting unit, for detecting a voltage of at least one light emitting component;
a storage device, for storing a look-up table that comprises a corresponding relation between a plurality of voltages of the light emitting component and a plurality of luminance levels of the light emitting component; and
a microprocessor, coupled to the voltage detecting unit and the storage device, for determining a luminance level of the light emitting component according to the voltage and the corresponding relation.

2. The light emitting component control device of claim 1, wherein the light emitting component is a light emitting diode (LED).

3. The light emitting component control device of claim 2, wherein the microprocessor further generates a control signal according to the luminance level and a predetermined luminance level.

4. The light emitting component control device of claim 3, further comprising:
a driving unit, coupled to the microprocessor and the LED, for driving the LED according to the control signal.

5. The light emitting component control device of claim 2, wherein the voltage is a forward voltage.

6. The light emitting component control device of claim 1, wherein the look-up table comprises:
a first sub look-up table, comprising a corresponding relation between the plurality of voltages of the light emitting component and a plurality of temperatures; and
a second sub look-up table, comprising a corresponding relation between the plurality of temperatures and the plurality of luminance levels of the light emitting component.

7. The light emitting component control device of claim 1, being disposed in a display device.

8. A controlling method for light emitting components, comprising:
detecting a voltage of at least one light emitting component;
storing a corresponding relation between a plurality of voltages of the light emitting component and a plurality of luminance levels of the light emitting component; and
determining a luminance level of the light emitting component according to the voltage and the corresponding relation.

9. The controlling method of claim 8, wherein the light emitting component is a light emitting diode (LED).

10. The controlling method of claim 9, further comprising:
generating a control signal according to the luminance level and a predetermined luminance level.

11. The controlling method of claim 10, further comprising:
driving the LED according to the control signal.

12. The controlling method of claim 9, wherein the step of detecting the voltage of the light emitting component comprises detecting a forward voltage of the light emitting component.

13. The controlling method of claim 8, wherein the step of storing the corresponding relation between the plurality of voltages of the light emitting component and the plurality of luminance levels of the light emitting component comprises:
storing a corresponding relation between the plurality of voltages of the light emitting component and a plurality of temperatures; and
storing a corresponding relation between the plurality of temperatures and the plurality of luminance levels of the light emitting component.

14. The controlling method of claim 8, being applied to a display device.
